(19) United States
(12) Patent Application Publication
(10) Pub. No.: US 2008/0119136 A1
(43) Pub. Date: May 22, 2008

(54) Access point with bluetooth transducer

(76) Inventor: Taheer Khazi, Central Islip, NY (US)

Correspondence Address: FAY KAPLUN & MARCIN, LLP, 150 BROADWAY, SUITE 702, NEW YORK, NY, 10038, US

(21) Appl. No.: 11/562,134

(22) Filed: Nov. 21, 2006

(51) Int. Cl. H04B 7/00

(52) U.S. Cl. 455/41.2

(57) ABSTRACT

An access point having a memory storing configuration settings for the access point and a Bluetooth receiver receiving data, wherein the data includes new configuration settings for the access point, the memory storing the new configuration settings. A method for receiving, by an access point, a first Bluetooth communication including identification data from a mobile unit, authenticating the mobile unit using the identification data, receiving a second Bluetooth communication including new configuration settings from the mobile unit and storing the new configuration settings in a memory of the access point.

### FIELD OF THE INVENTION

The present invention relates generally to access points with wireless configuration capabilities.

### BACKGROUND

Modern network infrastructures allow for interactivity between a variety of communication devices. These networks permit interaction between those devices with sources to a server (e.g. routers, hubs, switches, etc.) and proximately located wireless devices (e.g. access points, wireless routers, cellular base stations, etc). In the event that a network infrastructure requires modifications be made to the performance of access point devices, users may rectify these problems over wired communication networks (e.g. serial connections).

### SUMMARY OF THE INVENTION

An access point having a memory storing configuration settings for the access point and a Bluetooth receiver receiving data, wherein the data includes new configuration settings for the access point, the memory storing the new configuration settings.

A method for receiving, by an access point, a first Bluetooth communication including identification data from a mobile unit, authenticating the mobile unit using the identification data, receiving a second Bluetooth communication including new configuration settings from the mobile unit and storing the new configuration settings in a memory of the access point.

A method for establishing a Bluetooth connection with a device, receiving configuration settings from the device via the Bluetooth connection, implementing the configuration settings and terminating the Bluetooth connection.

### DESCRIPTION OF THE DRAWINGS

FIG. 1 shows an exemplary embodiment of an interactive network infrastructure involving wired and wireless device communications.

FIG. 2 shows an exemplary embodiment of an access point according to the present invention.

FIG. 3 shows an exemplary embodiment of a mobile unit according to the present invention.

FIG. 4 shows an exemplary embodiment of a method for configuration of an access point according to the present invention.

### DETAILED DESCRIPTION

The present invention may be further understood with reference to the following description and the appended drawings, wherein like elements are referred to with the same reference numerals. The present invention describes an access point (AP) or any other type of wireless infrastructure device such as a cell station, router, switch, etc. with wireless and wired communication capabilities.

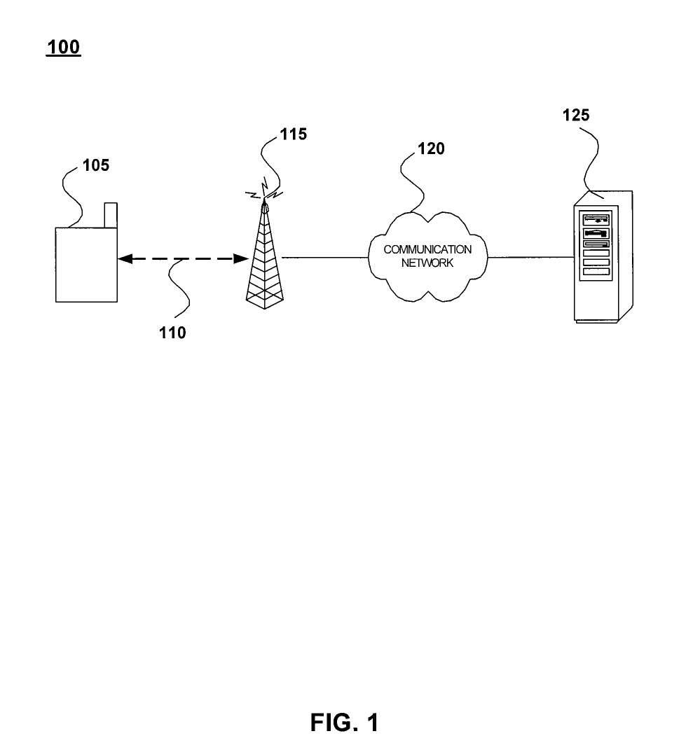

FIG. 1 shows an exemplary embodiment of an interactive network infrastructure 100. An interactive network infrastructure 100 comprises a mobile unit (MU) 105 wirelessly communicating with an AP 115. The AP 115 may communicate with the mobile unit MU 105 over a wireless link 110. The AP 115 may communicate with a network server 125 via a communication network 120 (e.g. an Internet, a LAN, etc.). An interactive network infrastructure 100 according to the exemplary embodiment of the present invention may include any number of MUs and APs in wireless communication over wireless links. According to the exemplary embodiments of the present invention, the MU 105 may establish wireless interactions with the AP 115, while the AP 115 may interact through the communication network 120 via wired communications with the network server 125 or any other type of network device. Those skilled in the art will understand that the exemplary embodiments of the present invention may be implemented in a network having any type of architecture and thus, the network infrastructure 100 is only exemplary.

Both the MU 105 and AP 115 may contain wireless communication components (e.g. wireless transmitter and wireless receiver) for wirelessly communicating over the wireless link 110, to perform various functions. The wireless link 110 may operate through use of wireless communication protocols known to those skilled in the art (e.g., an IEEE 802.1x protocol, a WAN Protocol, etc.).

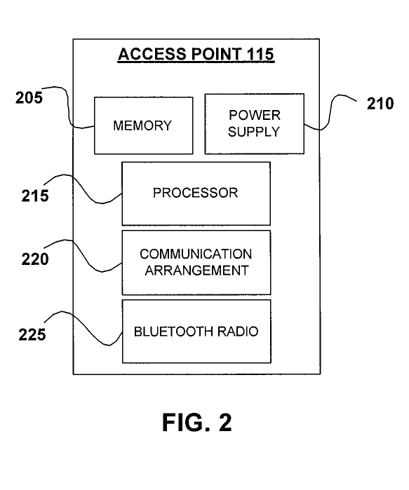

FIG. 2 shows an exemplary embodiment of the AP 115 and represents its components in block diagram form. The AP 115 may include a memory 205, a power supply 210, a processor 215, a communication arrangement 220, and a Bluetooth radio 225 (e.g. Bluetooth transmitter and/or receiver). Those skilled in the art will understand that an AP may have additional components that are not shown in FIG. 2. The exemplary embodiments of the present invention may be implemented on an AP that has more or less components as shown in FIG. 2.

According to the exemplary embodiments of the present invention, the AP 115 may be coupled to the server 125 via the communication network 120. The communication network 120 may permit interaction between the AP 115 and the server 125 via a wired link (e.g. Ethernet cables, coaxial cables, fiber optics, etc.). The communication between the AP 115 and the communications network 120 (or devices connected to the communication network 120) is facilitated through the communication arrangement 220. Those skilled in the art will understand that the communication arrangement 220 may be implemented as hardware, software or a combination thereof. Thus, the processor 215 may execute code that also facilitates communication and implements some of the functionality described herein for the communication arrangement 220.

In addition to facilitating communication with the communication network 120, the communication arrangement 220 also facilitates wireless communication between the AP 115 and the MU 105 via the communication link 110. The hardware and/or software implementing this functionality may be the same or different from the hardware and/or software implementing the functionality for communication with the communication network 120 described above.

In order for the AP 115 to operate correctly, e.g., to act as the conduit for communications between the MU 105 and the other devices connected to the communication network 120, the AP 115 must be configured for operation on the network 100. Each AP that is connected to the network 100 may have the same or different configuration settings based on a variety of factors such as, the number of MUs that are expected to connect to the AP, the functions that are being carried out by the MUs that are expected to connect to the AP, the physical location of the AP, the level of security that the AP must exhibit, etc.

These configuration settings for the AP 115 may be stored in the memory 205 of the AP 115. The memory 205 may comprise, for example, one or more databases (or other data storage mechanisms) for storing the configuration settings (e.g., beacon identification, channel selection, power settings, wireless protocol features, etc.). As described above, these configuration settings instruct the operation of the AP 115 prior to communication with any other device and when in communication with other devices (e.g., MU 105, server 125, etc.). The memory 205 may be, for example, a hard drive, flash drive, RAM, etc, and may store other information in addition to the configuration settings.

The configuration settings may be preloaded into the memory 205 of the AP 115 so that when the AP 115 is inserted into the network 100, the AP 115 may begin operation. This preloading of configuration settings may be done by the manufacturer of the AP 115 or by a system administrator based on the expected performance required of the AP 115.

However, during operation of the AP 115, the system administrator may desire to change the configuration settings based on any number of circumstances, e.g., the AP 115 is moved to a new physical location, the protocol used by the network 100 is changing, new MUs are being deployed on the network 100, etc. If the system administrator desires to change the configurations settings or load new configurations settings into memory 205, the system administrator must access the memory 205 via communication network 120, for example, by logging into network server 125 and accessing the memory 205 of the AP 115 to which the configuration changes are to be made. However, in many instances, a network 100 is distributed over a large geographical area, among various buildings or other locations. Thus, the system administrator accessing network server 125 may be remote from the AP 115 that is to be reconfigured. This may lead to certain disadvantages from being able to locally change or load configuration settings, e.g., the system administrator may desire to test network operation in the vicinity of the AP 115 after changing the configuration settings.

According to an exemplary embodiment of the present invention, the preloaded configuration settings (or any configuration settings that are currently stored) on the memory 205 may be locally reconfigured via a communication received at the AP 115 using the Bluetooth radio 225. The new configuration settings may provide instructions for operation of the AP 115 that may differ from the preloaded or previously stored configuration settings.

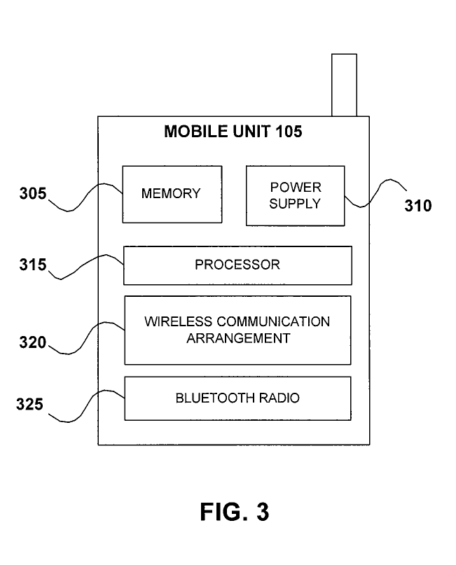

FIG. 3 illustrates an exemplary embodiment of the MU 105 and represents its components in block diagram form. In an exemplary embodiment of the present invention, the AP memory 205 is accessible by the MU 105. This accessibility is facilitated via the Bluetooth radio 225 of the AP 115 and the Bluetooth radio 325 of the MU 105. This accessibility will be described in greater detail below. The MU 105 may be any wirelessly enabled mobile device (e.g., laser based scanners, image based scanners, RFID devices, PDAs, mobile phones, portable game consoles, laptops, etc.). The components of the MU 105 may include a memory 305, a power supply 310, a processor 315, a communication arrangement 320 and a Bluetooth radio 325. The MU 105 may be utilized in any number of environments, including, but not limited to, offices, warehouses, retail stores, outdoors, etc. Those skilled in the art will understand that the MU 105 may include other components not shown in FIG. 3, such as input devices, display devices, etc.

According to the exemplary embodiments of the present invention, new configuration data for the AP 115 may be stored in the memory 305 of the MU 105. The memory 305 may be, for example, a hard drive, flash drive, RAM, etc. The configuration data for the AP 115 may be input into the memory 305 in a variety of manners. For example, the system administrator using the MU 105 may enter the configuration data using an input device of the MU 105 (e.g., keyboard entry, bar code scanning, etc.). In another example, the memory 305 may be a preloaded flash card that is inserted into the MU 105. In a further example, the system administrator may download the configuration data from the network server 125 using the wireless communication arrangement 320. As will be described in an example below, the new configuration settings may not be stored permanently in the MU 305, but may just be stored temporarily while being transmitted to the AP 115.

In an exemplary embodiment according to the present invention, the MU 105 may utilize configuration means (e.g. software, applet, program code, etc.) to modify the current AP 115 configuration settings stored on the AP memory 205 using AP configurations stored on the MU memory 305. The configuration settings stored in the memory 305 of the MU 105 may be transmitted via the Bluetooth radio 325 of the MU 105 to the Bluetooth radio 220 of the AP 115. The new configuration settings transmitted by the MU 105 may be stored in the memory 305 of the AP 115. The AP 115 may then implement the new configuration settings and operate consistent with the new configuration settings. Since the Bluetooth radios operate locally (e.g., when the MU 105 is in the vicinity of the AP 115), the system administrator may be in the vicinity of the AP 115 with an MU terminal 105 and, thus, can test the operation of the AP 115 after the new configuration settings are loaded. Those skilled in the art will understand that there may be other reasons why the system administrator may desire to be local to the AP 115 when changing configuration settings in addition to testing the AP 115, e.g., the physical location may determine the configuration settings.

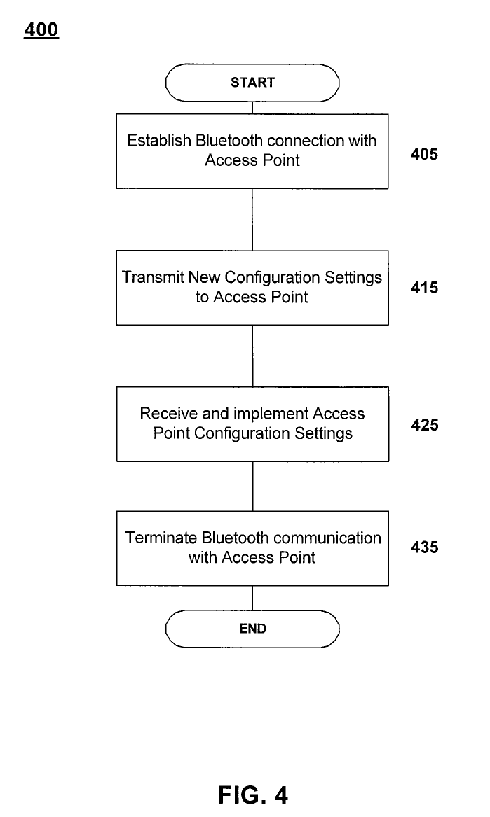

FIG. 4 shows an exemplary embodiment of a method 400 for configuring the configuration settings of an AP according to the present invention. The exemplary method 400 will be described with reference to the AP 115 and MU 105 described with reference to FIGS. 1-3. In an exemplary embodiment of the present invention, a Bluetooth connection is established between the MU 105 and the AP 115 in step 405. In an exemplary embodiment, the user of the MU 105 will indicate the desire to establish a Bluetooth connection with the AP 115. The Bluetooth radio 325 of the MU 105 will send a connection request to the Bluetooth radio 225 of the AP 115. The Bluetooth radios 225 and 325 will perform the corresponding handshake routine according to the Bluetooth standard.

As part of this handshake routine, the AP 115 will authenticate the MU 105 so that configuration data may be transmitted from the MU 105 to the AP 115. Those skilled in the art will understand that the exemplary embodiments may use any type of authentication processes known in the art (e.g., password, IP address authentication, MAC address recognition, etc.). Since the exemplary embodiments of the present invention allow for local reconfiguration of the AP 115, it may be necessary to ensure that only authorized users have access to the configuration settings so that there is no malicious or unintentional reconfiguration of the AP 115. After the handshake routine is complete (including the authentication), the Bluetooth radio 325 of the MU 105 and the Bluetooth radio 220 of the AP 115 may communicate using the Bluetooth standard.

In step 415, the MU 105 may transmit the new configuration settings to the AP 115. There are a variety of manners that may be used to transmit the configuration settings to the AP 115. For example, once the MU 105 has been authenticated, the MU 105 may include an application that displays the configuration settings in a spreadsheet form, thereby allowing the system administrator to fill out the desired settings in the spreadsheet and then transmit the spreadsheet via the Bluetooth radio 325 to the AP 115. In another exemplary embodiment, the MU 105 may query the AP 115 to determine the current configuration settings that are stored in memory 205 of the AP 115. This information may then be pre-filled into the form displayed on the MU 105. The system administrator may then be able to change the desired settings in the spreadsheet and the changes, additions and/or deletions may then be transmitted to the AP 115.

In another exemplary embodiment, the MU 105 may store the complete set of desired configuration settings in a database (or other storage format) and once the MU 105 has been authenticated, the entire set of configuration settings may be transmitted via the Bluetooth radio 325 to the AP 115. In another exemplary embodiment, the desired configuration settings may be wrapped in an applet and the applet may be transmitted via the Bluetooth radio 325 to the AP 115. The applet may then be executed on the AP 115 to provide the AP 115 with the desired configuration settings. From the above examples, it should be apparent that there are numerous additional manners of transmitting the new configuration settings to the AP 115.

In step 425, the AP 115 configuration settings are received and implemented at the AP 115. As described above, in step 415, the system administrator may, through a variety of methods, transmit new configuration settings from the MU 105 to the AP 115. The physical transmission of these new configuration settings is from the Bluetooth radio 325 of the MU 105 to the Bluetooth radio 220 of the AP 115. Once the AP 115 receives the new configuration settings, the AP 115 (as part of step 425) will store the new configuration settings in the memory 205. Those skilled in the art will understand that the software and/or hardware on the AP 115 will be provided to receive the communication including the new configuration settings by the Bluetooth radio 225 and store the new configuration settings in the memory 205.

As an additional portion of step 425, the new configuration settings will be implemented on the AP 115. Thus, the processor 215 (or other combination of hardware and/or software) will reconfigure the AP 115 based on the new configuration settings. The AP 115 will then be ready to operate consistent with these new configuration settings.

In step 425, the MU 105 may terminate Bluetooth communications with the AP 115. The termination of the communication may be performed immediately upon the sending of the new configuration settings (e.g., after step 415) or may occur later to allow for the new configuration settings to be stored and implemented on the AP 115. In the case of the later termination, the AP 115 may send a confirmation message to the MU 105 stating that the new configuration settings have been successfully (or unsuccessfully) stored and implemented. In addition, the termination of the Bluetooth communication may wait until the AP 115 has been tested with the new configuration settings. The termination of the communication may be manually selected by the user of the MU 105 or may be performed automatically by the MU 105 or the AP 115.

While the above description focused on the MU device configuring the AP device via the secure Bluetooth connection, it may also be possible that the configuration or configuration changes may be made to the MU via the Bluetooth connection. For example, the AP 115 may store configuration information for one or more MUs (e.g., MU 105) in memory 205. The configuration information may be stored based on MU identifications such as MAC addresses, IP addresses, or based on MU classes such as device types, device locations, etc. When the MU 105 connects to the AP 115 using the Bluetooth radios 225, 325, the method 400 described with reference to FIG. 4 may be performed, except that in steps 415 and 425, the new configuration settings may be transmitted from the AP 115 to the MU 105 (step 415) and the MU 105 may then receive, store and implement the configuration settings (step 425). Thus, the method may be performed for setting new configuration settings for either the AP 115 or the MU 105.

It should also be noted that the establishing of the Bluetooth communication between the MU 105 and the AP 115 may also be used to simplify the processes for other communications between the MU 105 and the AP 115 (e.g., via communications arrangements 220, 320). For example, once the Bluetooth connection is established (e.g., by the user of the MU 105 entering a password or PIN to be authenticated by the AP 115), additional data may be passed over the Bluetooth connection that is used for other types of communication.

For example, if a WEP key is required for IEEE 802.11x communications via the communication arrangements 220, 320, the MU 105 may send the WEP key to the AP 115 using the Bluetooth radios 225, 325 to authenticate the MU 105 for 802.11x communication with the AP 115. This may eliminate the need for the user of the MU 105 to enter the WEP key when attempting to access the AP 115 for 802.llx communications. Thus, when the user of the MU 105 desires to establish 802.11x communication with the AP 115, the step of authentication via the exchange of a WEP key does not need to be performed because it has been pre-performed over the Bluetooth connection. Those skilled in the art will understand that the use of 802.11x and/or WEP keys is only exemplary and that any type of data that may be used to facilitate non-Bluetooth communications may be exchanged via the Bluetooth connection.

It will be apparent to those skilled in the art that various modifications may be made in the present invention, without departing from the spirit or scope of the invention. Thus, it is intended that the present invention cover the modifications and variations of this invention provided they come within the scope of the appended claims and their equivalents.

What is claimed is:

1. An access point, comprising:
a memory storing configuration settings for the access point; and
a Bluetooth receiver receiving data, wherein the data includes new configuration settings for the access point, the memory storing the new configuration settings.

2. The access point of claim 1, wherein operation of the access point is reconfigured based on the new configuration settings.

3. The access point of claim 1, wherein the memory receives a request for the configuration settings.

4. The access point of claim 2, wherein the Bluetooth receiver is a Bluetooth transceiver and the access point fulfills the request by transmitting the configuration settings via from the Bluetooth transceiver.

5. The access point of claim 1, further comprising:
authentication means for authenticating a device sending the data prior to receiving the data and storing the new configuration settings.

6. The access point of claim 1, further comprising:
implementation means for implementing the new configuration settings on the access point.

7. The access point of claim 1, wherein the data is received from a Bluetooth transmitter of a mobile device.

8. The access point of claim 1, wherein the memory is one of a hard drive, a flash drive and random access memory.

9. The access point of claim 1, wherein the configuration settings include one of a beacon identification, a channel selection, a power setting and a wireless protocol feature.

10. A method, comprising:
receiving, by an access point, a first Bluetooth communication including identification data from a mobile unit;
authenticating the mobile unit using the identification data;
receiving a second Bluetooth communication including new configuration settings from the mobile unit; and
storing the new configuration settings in a memory of the access point.

11. The method of claim 10, further comprising:
implementing the new configuration settings in an operation of the access point.

12. The method of claim 10, further comprising:
receiving a third Bluetooth communication including a request for current configuration settings stored in the memory.

13. The method of claim 10, further comprising:
sending a third Bluetooth communication including current configuration settings stored in the memory.

14. The method of claim 10, wherein the authenticating includes one of verifying a password, verifying an IP address of the mobile unit and verifying a MAC address of the mobile unit.

15. The method of claim 10, wherein the new configuration settings include one of a beacon identification, a channel selection, a power setting and a wireless protocol feature.

16. An access point, comprising:
a memory means for storing configuration settings for the access point; and
a receiver means for receiving data, wherein the data includes new configuration settings for the access point, the memory storing the new configuration settings.

17. The access point of claim 16, further comprising:
implementation means for implementing the new configuration settings on the access point.

18. The access point of claim 16, further comprising:
a transmitter means for transmitting data, the data including the configuration settings stored in the memory means.

19. The access point of claim 16, further comprising:
authentication means for authenticating a device sending the data prior to receiving the data and storing the new configuration settings.

20. A method, comprising:
establishing a Bluetooth connection with a device;
receiving configuration settings from the device via the Bluetooth connection;
implementing the configuration settings; and
terminating the Bluetooth connection.
